(19) United States
(12) Patent Application Publication
(10) Pub. No.: US 2026/0117999 A1
(43) Pub. Date: Apr. 30, 2026

(54) SOLAR FAN ASSEMBLY FOR A BUILDING STRUCTURE

(71) Applicant: QC Manufacturing, Inc., Temecula, CA (US)

(72) Inventor: Dustin Martin Stevenson, Menifee, CA (US)

(21) Appl. No.: 19/371,902

(22) Filed: Oct. 28, 2025

Related U.S. Application Data
(60) Provisional application No. 63/713,543, filed on Oct. 29, 2024.

(51) Int. Cl. F24F 7/02; F04D 25/06; F04D 25/08; H02J 7/35; H02S 20/22

(52) U.S. Cl. CPC F24F 7/025; F04D 25/06; F04D 25/08; H02J 7/35; H02S 20/22; F24F 2221/02

(57) ABSTRACT

A self-contained solar fan assembly to cause airflow through a building or a shed. The solar fan assembly comprises a housing comprising a shaft connecting the inside and the outside of the building structure; a fastening collar configured to secure the housing across a hole of the building; a solar panel connected to a top portion of the housing on the outside of the hole; a fan arranged configured to direct an airflow through the cavity and powered by the solar panel. The solar fan assembly may further comprise a motion-sensitive light powered by the solar panel or a battery charged by the solar panel.

### INCORPORATION BY REFERENCE TO ANY PRIORITY APPLICATIONS

Any and all applications for which a foreign or domestic priority claim is identified in the Application Data Sheet as filed with the present application are incorporated by reference and made a part of this specification.

### BACKGROUND

### Field

Certain embodiments discussed herein relate to solar fans for ventilating building structures.

### Description of the Related Art

Outdoor building structures such as utility spaces, including sheds, can become heated or lack air circulation for operations taking place inside, causing discomfort or even safety issues to users, or causing deterioration of the structure and the objects within. A fan can actively provide cooling or air circulation to the utility space, enhancing the quality of the utility space. A solar panel can serve as a self-contained power supply to electrical appliances.

### SUMMARY

In some aspects, the techniques described herein relate to a solar fan assembly for ventilating building structures such as sheds, greenhouses, and portable restrooms. The solar fan assembly can a solar panel mounted on the exterior to generate electricity to power a fan and/or charge a battery. The fan can be located within a shaft that connects the inside and outside of the building. The fan air circulates through the building structure to reduce heat. The assembly can include a light. The light can be motion-activated and powered by the battery, including when sunlight is unavailable. The solar fan assembly can be mounted on walls, roofs, or existing exhausts. A printed circuit board can manage the fan, light, and battery, and sensors can automate their operation.

In some aspects, the techniques described herein relate to a solar fan assembly to cause airflow through a building structure, the solar fan assembly including: a housing including a shaft configured to extend from an inside of a building structure to an outside of the building structure, the shaft forming a cavity configured to direct airflow between the inside of the building structure and the outside of the building structure; a fastening collar configured to be removably attached to the shaft to secure the housing to the building structure; a solar panel connected to a top portion of the housing on the outside of the building structure, the solar panel configured to generate electricity from sunlight or ambient light; a fan arranged in the shaft, the fan configured to direct airflow through the cavity, the fan in electrical communication with the solar panel to power the fan with the solar panel generating electricity from sunlight or ambient light; a light attached to a bottom portion of the housing on the inside of the building structure; and a battery in electrical communication with the solar panel to charge the battery with the solar panel generating electricity from sunlight or ambient light, the battery in electrical communication with the light to power the light, wherein the battery is configured to power the light without the solar panel generating electricity.

In some aspects, the techniques described herein relate to a solar fan assembly, wherein the electricity generated by the solar panel simultaneously powers the fan and charges the battery.

In some aspects, the techniques described herein relate to a solar fan assembly, wherein the light includes a detector and the light is switched on or off in response to the detector detecting a signal.

In some aspects, the techniques described herein relate to a solar fan assembly, wherein the detector is a motion detector, and the light is switched on in response to the detector detecting a motion.

In some aspects, the techniques described herein relate to a solar fan assembly, wherein the fan is configured to cause an air exchange between the inside of the building structure and outside of the building structure, thereby ventilating the building structure or equilibrating a temperature inside the building structure with a temperature outside of the building structure.

In some aspects, the techniques described herein relate to a solar fan assembly, wherein the solar fan assembly is configured to reduce a temperature inside the building structure.

In some aspects, the techniques described herein relate to a solar fan assembly, wherein the housing includes a first thread, and the fastening collar includes a second thread corresponding to the first thread, and wherein the solar fan assembly is fastened to the building structure by screwing the second thread to the first thread.

In some aspects, the techniques described herein relate to a solar fan assembly, wherein the solar fan assembly further includes a seal arranged between the housing and an external surface of the building structure, preventing fluid or debris from entering the building structure.

In some aspects, the techniques described herein relate to a solar fan assembly, wherein the solar fan assembly further includes a PCB configured to control at least one of the fan, the light, or the battery.

In some aspects, the techniques described herein relate to a solar fan assembly, wherein the fan further includes a plurality of blades and a motor configured to rotate the plurality of blades about an axis of the shaft.

In some aspects, the techniques described herein relate to a solar fan assembly to cause airflow through a building structure, the solar fan assembly including: a housing including: a shaft configured to extend through an opening in a roof of the building structure, the shaft forms a cavity connecting an inside of the building structure to an outside of the building structure; and a top portion connected to a top end of the shaft configured to be arranged on the outside of the building structure; a solar panel connected to the top portion of the housing, the solar panel configured to generate electricity from sunlight or ambient light; a fastening collar configured to be removably attached to a bottom end of the shaft and to secure the housing to the roof, wherein the fastening collar is configured to press against the roof from the inside of the building structure, creating a tension in the shaft, and to cause the top portion of the housing to press against the roof of the building structure from the outside of the building structure; and a fan configured to direct airflow through the cavity, wherein the fan is in electrical communication with the solar panel to power the fan with the solar panel generating electricity from sunlight or ambient light.

In some aspects, the techniques described herein relate to a solar fan assembly, wherein the bottom end of the shaft is configured to protrude from under the roof.

In some aspects, the techniques described herein relate to a solar fan assembly, wherein the solar panel is configured to be arranged above the roof.

In some aspects, the techniques described herein relate to a solar fan assembly, wherein the top portion of the housing further includes a top cover with an upper surface and a lower surface, wherein the upper surface is connected to the solar panel and the lower surface is connected to the top end of the shaft, and wherein the lower surface includes vents connecting the cavity to the outside of the building structure.

In some aspects, the techniques described herein relate to a solar fan assembly, wherein the shaft includes a first mechanism, and the fastening collar includes a second mechanism configured to be fastened to the first mechanism, preventing the fastening collar from sliding relative to the shaft in an axial direction of the shaft.

In some aspects, the techniques described herein relate to a solar fan assembly, wherein the shaft includes a cylindrical body at least partially by an external thread, wherein the fastening collar includes an annular frame at least partially covered by an internal thread matching the external thread of the shaft.

In some aspects, the techniques described herein relate to a solar fan assembly to cause airflow through a building structure, the solar fan assembly including: a housing including a shaft configured to extend from an inside of a building structure to an outside of the building structure, the shaft forming a cavity configured to cause airflow between the inside of the building structure and the outside of the building structure; and a fastening collar configured to be removably attached to the shaft, to secure the housing to the building structure; a solar panel connected to a top portion of the housing on the outside of the building structure, the solar panel configured to generate electricity from sunlight or ambient light; a fan arranged in the shaft, the fan configured to direct airflow through the cavity, the fan in electrical communication with the solar panel to power the fan with the solar panel generating electricity from sunlight or ambient light.

In some aspects, the techniques described herein relate to a solar fan assembly, wherein the fan is configured to direct airflow from the inside of the building structure to the outside of the building structure.

In some aspects, the techniques described herein relate to a solar fan assembly, wherein an output power of the fan is proportional to an electrical power generated by the solar panel.

In some aspects, the techniques described herein relate to a solar fan assembly, wherein the housing further includes an inlet at a bottom portion of the shaft connecting the cavity to the inside of the building structure.

In some aspects, the techniques described herein relate to a solar fan assembly, wherein the top portion of the housing further includes an outlet on the outside of the building structure, connecting the cavity to the outside of the building structure.

In some aspects, the techniques described herein relate to a solar fan assembly, wherein a gap is formed between the top portion of the housing and the building structure, wherein an opening of the cavity is configured to direct air to flow through the gap.

In some aspects, the techniques described herein relate to a solar fan assembly, wherein the shaft includes a first thread, and the fastening collar includes a second thread matching the first thread, and wherein the solar fan assembly is fastened to the building structure by screwing the second thread to the first thread.

In some aspects, the techniques described herein relate to a solar fan assembly, wherein the solar fan assembly further includes an adapter configured to attach the housing to an exhaust of the building structure, such that the cavity of the shaft is connected to a cavity of the exhaust, and wherein a first end of the adapter is configured to connect to a bottom portion of the housing, and a second end of the adapter is configured to connect to the exhaust.

This Summary is provided to introduce a selection of concepts in a simplified form that are further described below in the Detailed Description. This Summary is not intended to identify key features or essential features of any subject matter described herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 is a section view of a structure showing a solar fan assembly secured to a building structure.

FIGS. 2A and 2B are perspective views showing a housing of a solar fan assembly.

FIG. 3 is a closeup section view showing a solar fan assembly secured to a wall or a roof of a building structure.

FIGS. 4A and 4B are a perspective views showing a portion of a housing of a solar fan assembly.

FIGS. 5A and 5B are a perspective views showing another portion of a housing of a solar fan assembly.

FIG. 6 is a perspective view showing a portion of a fan of a solar fan assembly.

FIG. 7 is a perspective view showing a fastening collar of a solar fan assembly.

FIG. 8 is a perspective views showing a solar fan assembly configured to be secured to an exhaust with an adapter.

FIG. 9 shows an electrical connection of a solar fan assembly.

FIGS. 10A and 10B are perspective views showing a solar fan assembly with lights.

FIG. 11 is a closeup section view showing a solar fan assembly with lights secured to a wall or a roof of a building structure.

FIGS. 12A and 12B are a perspective views showing a portion of a housing of a solar fan assembly with lights.

FIGS. 13A and 13B are a perspective views showing another portion of a housing of a solar fan assembly with lights.

FIG. 14 shows an electrical connection of a solar fan assembly with lights.

FIG. 15 shows another electrical connection of a solar fan assembly with lights.

### DETAILED DESCRIPTION

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extend beyond the specifically disclosed embodiments, examples, and illustrations, and can include other uses of the inventions and obvious modifications and equivalents thereof. In addition, embodiments of the inventions can comprise several novel features and no single feature is solely responsible for its desirable attributes or is essential to practicing the inventions herein described.

Outdoor utility space (for instance, a storage shed, an agriculture shed such as a greenhouse, or a mobile building structure such as a portable restroom) can become overheated or lack an integrated way for ventilation, causing discomfort or reducing the effectiveness of the space. In some cases, an outdoor building structure (for instance, a portable restroom) may also benefit from an active source of exhaust or ventilation, capable of causing air exchange between the inside and outside of the structure. In some cases, sunlight or other environmental heating factor may cause the temperate inside utility space to be warmer than the temperature outside of the space (for example, unventilated small outdoor space may reach 50° F. warmer than the outside during a hot day), reducing the lifetime of the building structure of the objects or equipment inside, causing discomfort or even safety concerns to users of the spaces. In some cases, it may be inconvenient or disadvantageous to connect power cables to small, stand-alone, or utility building structures due to planning or cost concerns. A solar fan assembly 100 may be self-contained and does not require any externally wired power source to provide active airflow. A solar fan can convert and utilize the otherwise undesired sunlight to cool or ventilate the building structure, creating a more desirable or effective operating condition inside the structure at low maintenance and energy cost.

A solar fan assembly 100 may be provided with a solar panel 206 to generate electricity from sunlight, ambient light, or other sources of light 12, and in turn power the rest of the assembly. In some cases, a battery may be provided to store the electricity generated by the solar panel 206 during the day, and power the solar fan assembly 100 when not enough light is available, for example, on a cloudy day or during the night. In some cases, a built-in light may be provided with a solar fan assembly 100 to illuminate the inside of the structure, and the light may be powered by the battery. The solar fan may be attached to a wall or a roof 14 of a building structure through a hole. The solar panel 206 may have a shaft 106 that goes through a hole in a wall or a roof 14 of the building structure, with an end of the shaft 106 protruding from the inside of the wall or the roof 14. The protruded portion of the shaft 106 may then fit to a fastening collar or nut 104, attaching the assembly to the building structure. A portion of the solar fan assembly 100 arranged outside of the building structure may be weather/waterproof/resistant, and a seal may be provided between the solar fan assembly 100 and the wall or the roof 14, protecting the structure against environmental factors. In some cases, a solar fan assembly 100 may be connected to an exhaust tube using an adapter.

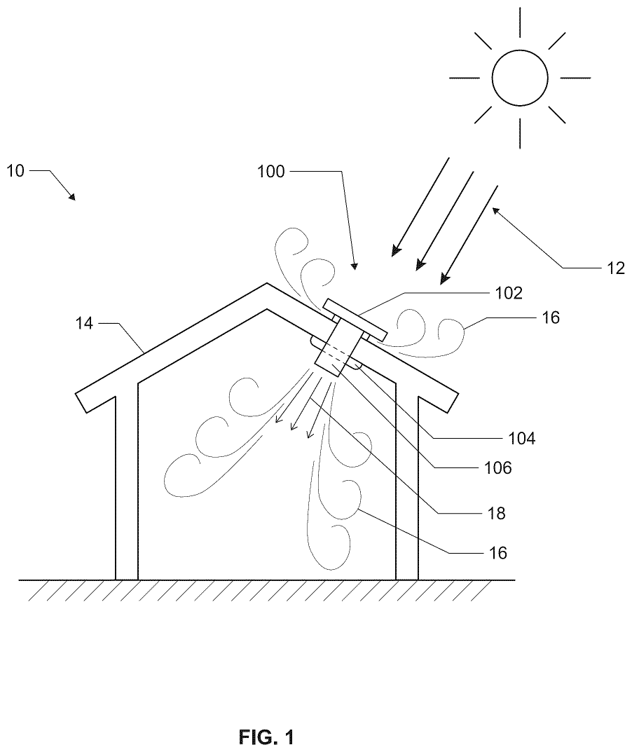

FIG. 1 shows sectional view of an embodiment of a solar fan assembly 100 secured to a building structure 10. As is shown in FIG. 1 a solar fan assembly 100 may be provided on a roof or a wall 14 of a building structure 10, or a portion of the building structure 10 that is at least partially exposed to light, for example, sunlight 12, or an external atmosphere. The solar fan assembly 100 may include a housing 102 including an elongated shaft 106 configured to be inserted through an opening or a hole of the building structure 10. In some cases, the opening or a hole may be a through hole. The opening or hole may directly or indirectly connect an inside of the building structure 10 to an outside of the building structure 10. In some cases, it may be preferable to arrange the opening or the hole in with substantially open or unblocked access to a major internal space inside of the building structure 10 to enhance the effectiveness of airflow 16 caused by the solar fan assembly 100. In some cases, the solar fan assembly 100 may be installed by inserting from the outside the building structure 10,

Still referring to FIG. 1, the housing 102 of the solar fan assembly 100 can have a top portion or a top panel 221 configured to be arranged on the outside of the building structure 10. In some cases, a surface of the top portion or top panel 221 of the housing 102 may be exposed from above, for example, exposed to a sunlight 12. The top surface of the housing 102 arranged above, flush with, or slightly lower than the top or outer surface of the roof or the wall 14. The top portion or top panel 221 of the housing 102 may have a significantly flat, planar, or disk-like shape, and may be arranged substantially in parallel to the portion of the roof of the wall 14 to which the solar fan assembly 100 is attached. A profile of the top portion of the housing 102 viewed from above may be round, square, or any other geometrical shape appropriate for its purposes. At least a portion of a bottom surface of the top portion or panel of the housing 102 may press against, sit against, directly contact, or adhere to the roof or the wall 14. A width at the bottom of the top portion or panel may be larger than a width at the top of the opening or hole in the wall or roof 14. When installed, a gap may remain between the solar fan assembly 100 and the building structure 10 to allow air to enter from or escape to the outside in a controlled or shielded fashion. In some cases, a gap may remain between a portion of a bottom surface of the top portion or panel and the roof or the wall 14. In some cases, a gap may be formed on an underside or a perimeter of the top portion or panel. The top portion or panel may include an air opening, a vent, an inlet, an outlet, or an exhaust.

Still referring to FIG. 1, a bottom end or surface of the top portion or panel of the housing 102 may be connected to the shaft 106 of the housing 102. During an installation of the solar fan assembly 100, the shaft 106 portion of the housing 102 may be inserted from the outside of the building structure 10 through the opening or hole of the roof or wall 14 into the inside of the building structure 10. In some cases, a cross-section shape of the opening or a hole may accommodate a cross-section of the shaft 106 at its widest point. During installation, the shaft 106 may be inserted from the outside of the building structure 10 until the bottom of the top portion of the housing 102 presses against the roof or the wall 14. In some cases, the solar fan assembly 100 may block or seal the opening or hole of the roof or wall 14, such that air may not enter or exit, except through an internal cavity of the solar fan assembly 100, in the vicinity of the opening or hole.

Still referring to FIG. 1, after installation, a bottom portion of the shaft 106 may be directly or indirectly exposed to the air or a major internal space of the building structure 10. A portion of the bottom end may protrude from beneath the roof or the inside of the wall to enhance the access of the solar fan assembly 100 to the inside of the building structure 10. The shaft 106 may include an air opening, a vent, an inlet, an outlet, or an exhaust or air to go through, for instance at a bottom portion of the shaft 106. In some cases, the solar fan assembly 100 can also have a light to illuminate 18 the inside of the building structure 10, for instance at a bottom portion of the shaft 106.

A bottom portion of the shaft 106 may further include a mechanical mating mechanism or element configured to be attached to a fastening nut or a collar. The fastening collar or nut 104 may be attached to the bottom end of the shaft 106 from the inside of the building structure 10, from inside of the wall, or from under the roof. When attached to the housing 102, the fastening collar or nut 104 may fasten, secure, fix, or tighten the solar fan assembly 100 to the building structure 10, preventing the solar fan assembly 100 from moving, shifting, rotating, vibrating, relative to the opening or hole. In some cases, when attached to the housing 102, the fastening collar or nut 104 may press against, directly contact, or adhere to the roof or the wall 14 from the inside. In some cases, when attached to the housing 102, the fastening collar or nut 104 may pull against the housing 102, causing a portion of the housing 102 to press against the roof or the wall 14 from the outside, thereby attaching or fastening the solar fan assembly 100 to the roof. For example, the fastening collar 104 may cause a bottom surface of the top portion of the housing 102 to press against or adhere to the roof or the wall 14, fastening, tightening, or sealing the solar fan assembly 100 with the building structure 10.

Still referring to FIG. 1, in some cases, the shaft 106 and the fastening collar or nut 104 may be provided with matching threads, clasps, buckles, screws, set screws, or a spring-loaded mechanism that may be tightened or fastened against each other. In some cases, a gasket, a seal ring, or a sealant may be provided around the shaft 106, between the shaft 106 and the hole portion of the roof or the wall 14, between the top portion of the housing 102 and the roof or the wall 14, or between the fastening collar 104 and the and the roof or the wall 14 to prevent water, debris, or other undesired substance from entering or exiting the structure. For example, a waterproof or water-resistant seal or sealing ring may be provided between the top portion of the housing 102 and the roof or the wall 14. In some cases, a buffering, strengthening, sealing, or adhesive element 240, such as an O-ring, a washer, a gasket, a tape, an adhesive, a sealant, or a tape may also be provided in between a portion of the solar fan assembly 100 and the building structure 10 to increase mechanical engagement such as grip, adhesion, or friction, or reduce mechanical stress or damage to the building structure 10, or provide seal or blockage against unwanted gas, liquid, or solid, when the solar fan assembly 100 is installed.

In some cases, a length of the shaft 106 of the housing 102 may be ¼-24 inches, ½-18 inches, 1-12 inches, or 2-6 inches. In some cases, a cross-sectional area of the shaft 106 of the housing 102 may be ½-100 in², 1-75 in², 2-60 in², 3 in²-50 in², or 5-30 in². In some case, a width or diameter of the cavity of the shaft 230 may be ½-24 inches, 1-12 inches, 2-8 inches, or 4-6 inches.

Still referring to FIG. 1 the building structure 10 may be a small or utility outdoor structure such as a storage/agriculture shed, a mobile shed, a greenhouse, a portable utility structure, or a portable restroom. In some cases, a height of the building structure 10 may be greater than 1 ft, 2 ft, 4 ft, 6 ft, 8 ft, 10 ft, 15 ft, or 20 ft. In some cases, an internal volume or a capacity of the building structure 10 may be greater than 2 ft³, 4 ft³, 8 ft³, 10 ft³, 15 ft³, 20 ft³, 30 ft³, 50 ft³, or 100 ft³. The building structure 10 may have a flat, slanted, or curved roof, and the solar panel 206 or the top surface of the solar fan assembly 100 may be arranged in parallel with the portion the roof it is attached to.

In some cases, the solar panel 206 may also be arranged at an angle to the roof, such that it is oriented to utilize more sunlight throughout a day or a year and increase the amount of electricity generated. The hole at which the shaft 106 of the solar fan assembly 100 fits through may be made perpendicular to the wall or the roof 14. A size of the hole may be larger than a width of the shaft 106 and may be smaller than a width of the fastening collar 104 or the top portion of the housing 102, such that the shaft 106 and the top portion may together press against the wall or the roof 14 from both sides and attach the solar fan assembly 100 to the building structure 10.

Still referring to FIG. 1, a portion of the solar fan assembly 100 may be hollow or form a cavity to allow air to flow between the inside of the building structure 10 and the outside of the building structure 10. For example, in some embodiments, the shaft 106 may be a hollow cylinder forming that connects the inside of the building structure 10 and the outside of the building structure 10. A fan may be provided in the cavity of the shaft 230 or aimed at the cavity of the shaft 230. In some embodiments, the fan may cause the air to flow through the cavity of the hollow shaft 106 from inside to outside, thereby ventilating the building structure 10. In some cases, the airflow may cause an equilibration between the temperature inside and outside of the building structure 10.

In some cases, the airflow may cause a cooling of the inside of the building structure 10 by replacing warmer air from the inside with cooler air from the outside. In some embodiments, it may be desirable for the fan to cause air to flow from outside to inside. In some embodiments, the fan may be capable of switching between different states of operation, causing air to flow either inward or outward through the shaft 106. In some cases, an electrical power of the fan may be 0.01-1000 Watts, 0.1-100 Watts, or 1-10 Watts. In some cases, the fan may cause an airflow between 1-1000 cubic feet per minute (CFM), 5-700 CFM, or 10-400 CFM. In some cases, the noise produced by the fan during operation may operate under 100A-weighted decibel (dB-A), 80 dB-A, 60 dB-A, 45 dB-A, 30 dB-A, 15 dB-A, or 5 dB-A. In some cases, for example, the building structure 10 may be a standard 6′ by 5′ shed, or has an internal volume of approximately 200 ft³, and the solar fan assembly 100 may cause a complete air exchange in less than 30 min, 20 min, 10 min, 5 min, 1 min, 30 seconds or 10 seconds, or more than 1, 2, 5, 10, 20, 50, 120, 200, or 500 complete air exchanges per hour.

Still referring to FIG. 1, in some embodiments, an inlet 210 of the cavity may be provided at the bottom end of the shaft 106 and inside the building structure 10. The inlet 210 may be arranged to face away from the wall or the roof 14 to increase the effectiveness of airflow or air exchange. In some cases, the inlet 210 may occupy a significant area of the bottom surface of the shaft 106. In some cases, an outlet 212 of the cavity may be provided in a portion of the housing 102 outside of the building structure 10 or above the roof. For example, in some cases, one or more outlets 212 may be arranged on a bottom surface of the top portion 221 of the housing 102, facing downward or opening toward a gap formed between the roof and the top cover 202 of the housing 102, thereby reducing the possibility of rain or other undesired environmental debris from entering the cavity. In some cases, the outlet 212 may be arranged on a perimeter of the top cover 202 to increase a cross-sectional area of the outlet 212 and thus increase the effectiveness of the airflow.

Still referring to FIG. 1, a solar panel 206 may be connected to the top portion 221 of the housing 102 of the solar fan assembly 100. The solar panel 206 may be provided on a top surface and may be arranged in parallel or flush with a top surface of the housing 102. In some cases, the orientation or position of the solar panel 206 may be adjusted by moving or rotating a part of the housing 102. The solar panel 206 may receive and convert sunlight 12 or other sources of external light or radiation energy and generate electricity which in turn powers the fan. In some cases, an area of the solar panel 206 may be greater than 1 in², 2 in², 5 in², 10 in², 20 in², 50 in², 100 in², 500 in², or 1000 in². In some cases, a power of the electricity generated by the solar panel 206 may be greater than 0.01 Watt, 0.1 Watt, 1 Watt, 5 Watt, 10 Watt, or 100 Watt. In some cases, the efficiency of conversion from light to electricity of the solar panel 206 may be greater than 1%, 5%, 10%, or 50%.

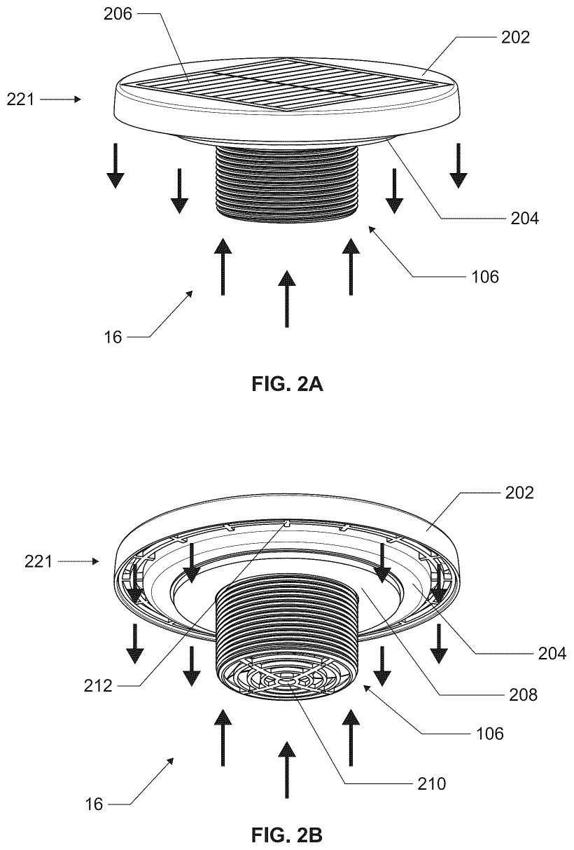

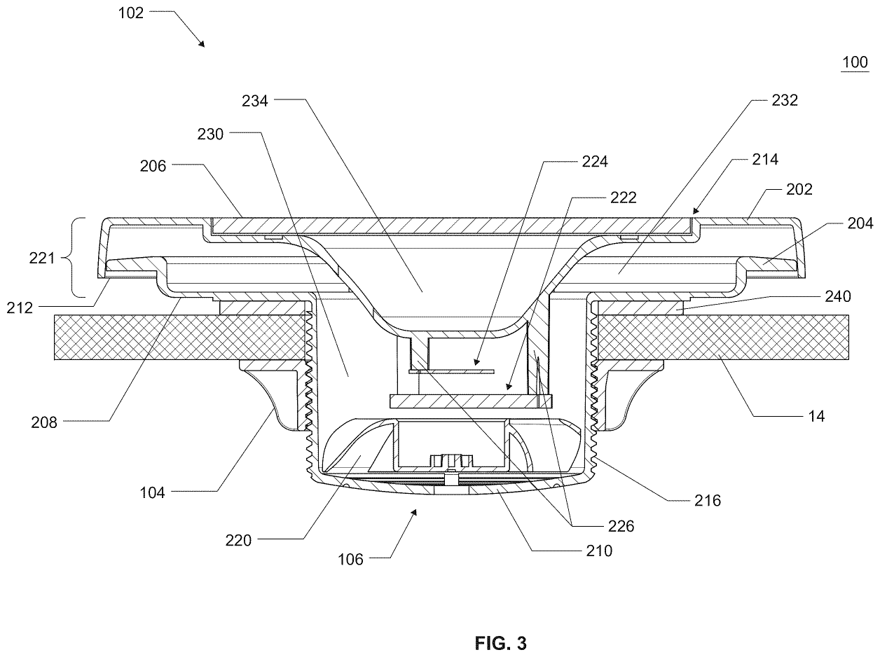

FIGS. 2A, 2B, and 3 show perspective views, from the above and below, respectively, of an embodiment of a housing 102 of a solar fan assembly 100. The thick black arrows in FIGS. 2A, 2B, and 3 show exemplary airflows through the solar fan assembly 100. FIG. 3 shows a section view of an embodiment of a solar fan assembly 100 secured to a wall or a roof 14 of a building structure 10. The housing 102 of the solar fan assembly 100 may include metal, plastic, polymer, carbon fiber, ceramic, or silicone.

As is shown in FIGS. 2A, 2B, and 3, a housing 102 of a solar fan assembly 100 may include a flat or planar top portion 221 and an elongated shaft 106 extending perpendicularly downward from a bottom surface of the top. The top portion 221 of the housing 102 may include a top cover 202, and a solar panel 206 may be attached or embedded in the top cover 202. The shaft 106 may be configured to be inserted or extended through a hole in a building structure. In some cases, the shaft 106 may be configured to directly contact, to be adhered to, or to be sealed against the side wall of the hole. In some cases, the shaft 106 may be configured to not directly contact the side wall of the hole or leave a gap between the shaft 106 and the side wall of the hole. The top portion 221 may be configured to be arranged outside of the building structure, with a bottom surface of the top portion 221 may be configured to press against an external surface of the building structure. In some embodiments, the bottom surface of the top portion 221 may directly press against or contact the external surface of the building structure. In some embodiments, the bottom surface of the top portion 221 may press against or directly contact a seal or a buffering element, and the seal or the buffering element in turn press against or directly contact the external surface of the building structure.

In some embodiments, the bottom surface of the top portion 221 may include a raised step 208, such that when the top portion 221 is pressed against a roof or a wall 14, only the bottom surface of the raised step 208 is in direct contact with or exerts pressure against the roof or the wall 14, whereas the rest of the receded portion of the bottom surface of the top portion 221 forms a gap with the roof or the wall 14. In some embodiments, such as the one shown in FIGS. 2A, 2B, and 3, the raised step 208 is provided in the shape of a ring centered around the shaft 106, and the rest of the receded portion of the bottom surface of the top portion 221 forms a larger ring around the raised step 208. The gap between the receded bottom surface of the top portion 221 and the roof or the wall 14 may be formed in the shape of a ring, with a height range of 1/16-12 inches, 1/16-8 inches, ⅛-5 inches, or 1-4 inches.

Still referring to FIGS. 2A, 2B, and 3, as mentioned herein, the shaft 106 may be a hollow structure that forms a cavity within. In some embodiments as shown in FIGS. 2A, 2B, and 3, the shaft 106 may be in the shape of a hollow cylinder. A thickness of the wall of the hollow cylinder may be 0.01-0.5 inches, 0.05-0.4 inches, or 0.0625-0.25 inches. In some cases, a top end of the hollow shaft 106 may be connected to the bottom or lower surface of flat top portion 221, and a bottom end of the hollow shaft 106 opens to the air. The opening on the bottom may extend into the inside of a building structure. When a fan causes air to flow from the inside to the outside of the building structure or from the bottom to the top of the cavity, the opening 210 at the bottom of the shaft 106 may serve as an inlet of the cavity. The inlet 210 may be covered with a fence, a grid, or a mesh to prevent foreign objects from entering the cavity.

Still referring to FIGS. 2A, 2B, and 3, in some cases, the shaft 106 may include a connecting element configured to be fastened to the fastening collar 104. For example, the shaft 106 may include a first part of a mechanism, and the fastening collar 104 includes the second part of the mechanism configured to be removably attached to the first part, and, once the second part is attached to the first part, the mechanism prevents the fastening collar 104 mechanism to slide off from the shaft 106. The connecting element may be a threading, a clamp, a clasp, a buckle, an adhesive, screws, set screws, or a spring-loaded connecting element. In some embodiment, at least a portion of the external side surface of the wall of the hollow shaft 106 may be threaded or include male threads 216, configured to be screwed into a matching female threads 704 of fastening collar 104. In some embodiments, the threads 216 may extend over 0-100%, 1-99%, 5-100%, 10-90%, or 20-80% of the length of the shaft 106. In some embodiments, the threads 216 may be provided in one or more separated strips along the circumference of the shaft 106. In some embodiments, the entire or almost the entire external surface of the shaft 106 may be covered by the thread. As the shaft 106 may be configured to go through and protrude from the roof or a wall 14 of a building structure to be connected to the fastening collar 104, it may be desirable to have the length of the shaft 106 or the length of the thread exceed typical thicknesses of walls and roofs to accommodate various common building structures. For example, the shaft 106 or the thread may have a length greater than ½ inch, 1 inch, 2 inch, 4 inch, 6 inch, 8 inch, 12 inch, or 16 inch.

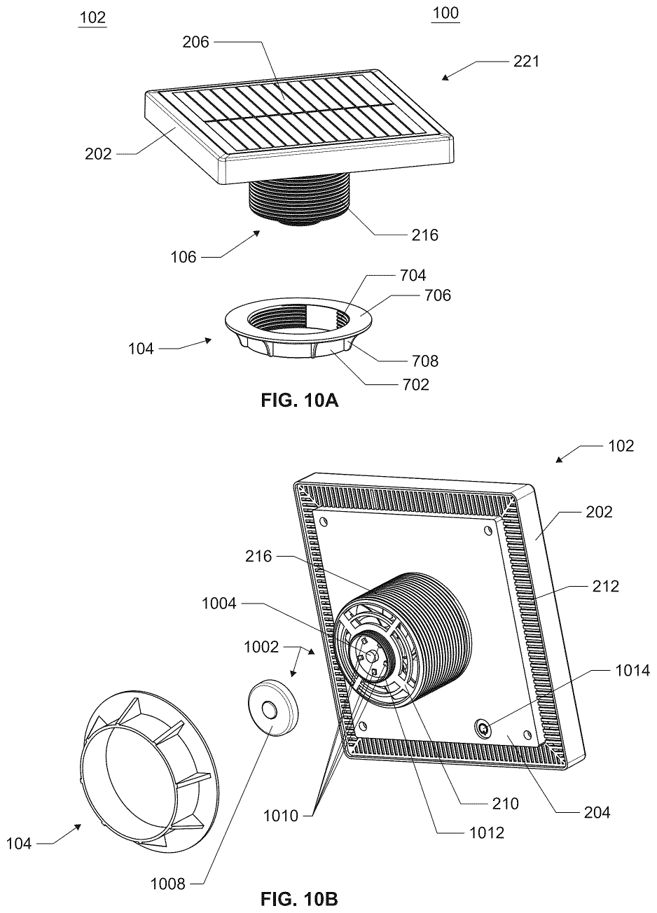

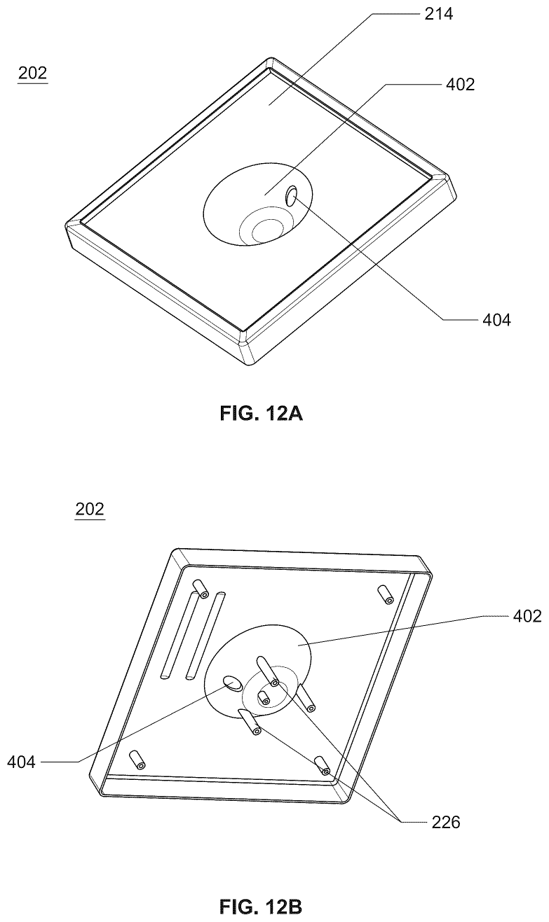

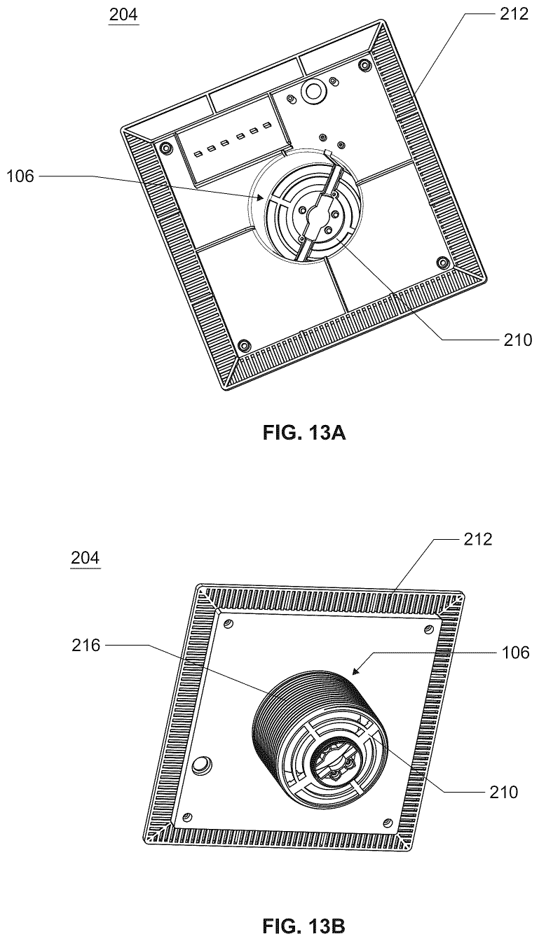

Referring to FIGS. 2A, 2B, 3, 12A, 12B, 13A, and 13B, in some cases, the top portion 221 of the housing 102 may be of a planer circular shape. In some cases, for example, as in the embodiment shown in FIG. 10A, the top portion 221 of the housing 102 may be of a planer rectangular or square shape. The top portion 221 of the housing 102 may include a top cover 202 and a bottom cover 204. A solar panel 206 comprising one or more solar cells may be connected to or be intercalated in the top cover 202. In some cases, a voltage generated by a solar cell of the solar panel 206 may be 0.01 V, 0.1 V, 0.5V, 1V, 2 V, 5 V, or 12 V. In some cases, a total voltage generated by the solar panel 206 may be 0.1-50V, 0.5-24V, or 0.5-12 V. In some cases, a power generated by a solar cell of the solar panel 206 may be greater than 0.01Watt, 0.05 Watt, 0.1 Watt, 0.5 Watt, 1 Watt, 2 Watt, 5 Watt, or 10 Watt. In some cases, a total power generated by the solar panel 206 may be greater than 0.1 Watt, 0.5 Watt, 1 Watt, 2 Watt, 5 Watt, 10 Watt, 20 Watt, 50 Watt, or 100 Watt.

The top cover 202 including the solar panel 206 may be configured to be water/weatherproof/resistant to protect the internal structures of the solar fan assembly 100 from undesirable environmental factors. The bottom cover 204 may include a bottom surface of the top portion 221 of the housing 102 and may include a raised step 208 and a receded portion forming a gap with the building structures as discussed herein. A top cavity connected to the cavity of shaft 230 may be formed between the top cover 202 and bottom cover 204 of the top portion 221 of the housing 102. Openings may be provided on the surface of the top portion 221 to serve as the outlet of the cavity 230 when air flows from the bottom to the top of the shaft 106, or from the inside to the outside of the building structure.

In some embodiments, for example, as shown in FIGS. 2A, 2B, and 3, the outlet 212 may be provided along a perimeter of the bottom cover 204 forming a ring around the shaft 106, facing downward or facing a wall or a roof 14, or be provided on the receded portion of the bottom surface of the top portion 221 of the housing 102. The outlet 212 may be arranged to be oriented towards the gap formed between the top portion 221 of the housing 102 and the roof or the wall 14, providing channel for airflow 16 to enter or exit, and at the same time preventing undesirable environmental fluid or debris from entering the system. To increase the effectiveness of the airflow 16, it may be desirable to have outlet 212 covering a large area of the top portion 221. In some cases, the outlet 212 may cover at least 1%, 5%, 10%, 20%, 50%, or 75% of an area of the bottom cover 204 of the top portion 221 of the solar fan assembly 100. The outlet 212 may be covered with a fence, a grid, or a mesh to prevent foreign objects from entering the cavity.

Referring to FIG. 3, in some embodiments a fan may be provided inside a cavity 230 of the of the solar fan assembly 100. In some embodiments, the fan may include a propeller element 220 configured to cause an airflow 16, a motor 222 configured to drive the propeller element 220, and a printed circuit board (PCB) 224 configured to control the motor 222.

Still referring to FIG. 3, in some cases, the propeller element 220 of the fan may be arranged at a bottom of the shaft 106 near the inlet or an opening 210 directed towards the inside of the building structure, and a width of the propeller element 220 may be approximately equal to or slightly smaller than the width of the cavity 230 of the shaft 106, enhancing an engagement of the propeller element 220 with the air inside the building element. In some cases, the fan may be an axial fan, and the propeller may be configured to rotate about a central axis of the cylindrical cavity 230 of the shaft 106. In some cases, the propeller element 220 may include a plurality of slanted blades 602 symmetrically attached to a central frame.

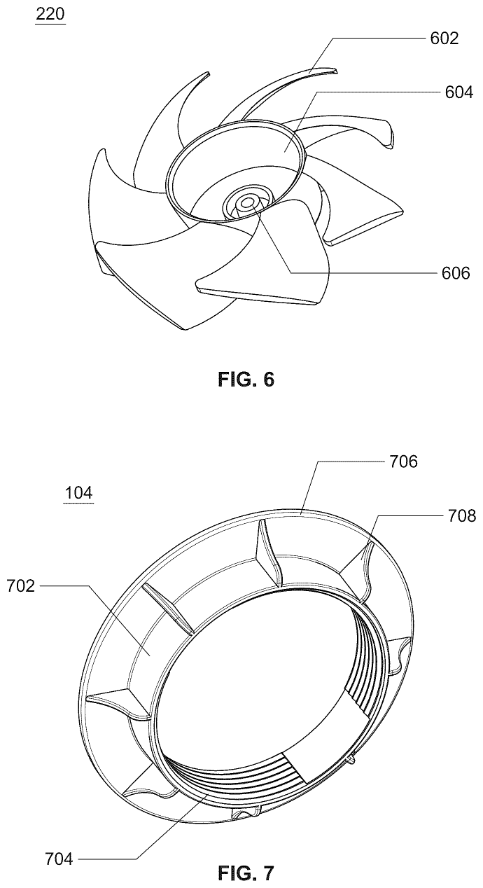

FIG. 6 shows a perspective view of an embodiment of a propeller element 220. As shown in FIG. 6, in some cases, a central frame 604 of the propeller element 220 may include a socket 606 configured to be attached to an axel, the axel may in turn to connected to a motor 222 of the fan, transmitting rotational motion from the motor 222 to the propeller element 220. In some cases, the motor 222 may be an electric motor, a DC motor, a brushless motor, and may operate at 0.1-25V, 0.5-12V, or 1-8V, for example, 5.5V, or 0.01-100 A, 0.05-10 A, 0.1-5 A, 0.5-2 A, for example, at 0.54 A. In some cases, a central frame 604 of the propeller element 220 may further include a cylindrical or annular frame 604 connected to and centered around the socket 606. A plurality of slanted blades 602 may extend radially outward from the cylindrical or annular frame 604. In some cases, a number of blades 602 of the propeller element 220 may be more than 2, 3, 4, 5, 6, 7, 8, 9, 10, 12, 15, or 20, for example, 9. The propeller element 220 of the fan may include metal, plastic, polymer, carbon fiber, ceramic, or silicone.

Still referring to FIG. 3, in some cases, a motor 222 or a PCB 224 of the fan may also be arranged inside the cavity 230 of the shaft 106. As shown in FIG. 3, a motor 222 or a PCB 224 may be arranged above the fan below the solar panel 206. The PCB 224 may be electrically connected to the solar panel 206 and the motor 222 and may include power circuits or logical circuits.

FIG. 9 shows a schematic of an embodiment of electrical connection of the solar fan assembly 100. As shown in FIG. 9, in some cases, electricity generated by the solar panel 206 is first passed from the solar panel 206 to the PCB 224, and then from the PCB 224 to the motor 222. In some cases, there may also be connections conducting electricity directly between the solar panel 206 and the fan. In some cases, the fan may further include a switch configured for a user to control the operation of the fan. In some cases, the fan may further include a detector or a sensor and an automatic switch automatically controlling the operation of the fan based on an output of the detector or the sensor. In some cases, for example, the fan may include a motion detector or a temperature sensor.

As cooling or ventilation may be desirable when the building structure is exposed to and heated by strong sunlight, it may be favorable to have the power of the fan positively correlated with a light level outside or heat level inside. In some cases, the fan may be powered by the electricity generated by the solar panel 206 in real time. For example, an instantaneous output power, driving power, rotational speed, driving voltage, driving current of the fan, rate of airflow, or air exchange rate caused by the fan may be positively correlated with an instantaneous electrical power generated by the solar panel 206, an instantaneous power of the light received by the solar panel 206, or an instantaneous brightness outside of the building structure. For example, in some cases, a driving power of the fan may be linearly proportional to the electrical power generated by the solar panel 206.

In some cases, the driving power of the fan may respond in a stepwise fashion to the electrical power generated by the solar panel 206, such that the fan operates at a constant power when the power generated by the solar panel 206 is above a limit. In some cases, when the solar panel 206 is exposed to a low level or no light, the fan may stop operating. In some embodiments, the fan may not operate when an electrical power generated by the solar panel 206 is below a predetermined level, for example, lower than 0.01 Watt, 0.1 Watt, 0.5 Watt, 1 Watt, or 5 Watt.

In some cases, the solar fan assembly 100 further includes a battery in electrical communication with the solar panel 206. The battery may be charged by the solar panel 206 and store energy when the light level or the amount of power generated by the solar panel 206 is high, for example, during the day, when the light to which the solar panel 206 is exposed to is bright or strong, or when the electrical energy generated by the solar panel 206 is above a predetermined limit. The solar panel 206 may simultaneously send electrical energy to the battery and the fan when the power generated by the solar panel 206 is high.

The battery may be configured to output the stored energy to power the fan, for instance when the light level or the amount of power generated by the solar panel 206 is low, for example, during a cloudy day, during the night, when the light to which the solar panel 206 is exposed to is dim or weak, or when the electrical energy generated by the solar panel 206 is below a predetermined limit. The battery may also be configured to output energy to assist the fan to operate or output at a certain requested level, for example, when a quality or level of the light to which the solar panel 206 is exposed varies, when power generated by the solar panel 206 varies, or when the power generated by the solar panel 206 is not sufficient for the fan to operate at the requested level. The requested level of the fan may be a constant power, larger than a certain power, or any other predetermined, programmed, or user requested level. The battery may stop drawing energy from the solar panel 206 when the power generated by the solar panel 206 is low, such that most or all the energy generated by the solar panel 206 may be used to operate the fan. In some cases, the fan may operate whenever the solar panel 206 is generating electricity. In some cases, the battery may be charged whenever the solar panel 206 is generating electricity. In some cases, the fan may receive at least 95%, 90%, 85, 80%,75%, 70%, 60%, 50%, 30%, or 10% of an instantaneous electrical power generated by the solar panel 206. In some cases, the battery may receive at least 80%, 60%, 40%, 30%, 25%, 20%, 15%, 10%, 5% of an instantaneous electrical power generated by the solar panel 206. In some cases, at least 90%, 95%, or 100% of the energy powering the fan is directly generated by the solar panel 206 without passing through the battery. In some cases, one or more internal circuits or a PCB 224 may determine, control, or adjust the power at which the fan operates, the power at which the battery stores energy, ratio of the power split between the battery and the fan depending on one or more electrical signals of the system, for example, from a user operable switch or a control, from a detector or a sensor that measures light, temperature, or motion of either the inside or the outside of the building structure. In some cases, the battery may store greater than 1 mAh, 5 mAh, 10 mAh, 20 mAh, 50 mAh, 100 mAh, 200 mAh, 500 mAh electrical energy when fully charged. In some cases, the battery may be a lithium or a rechargeable battery.

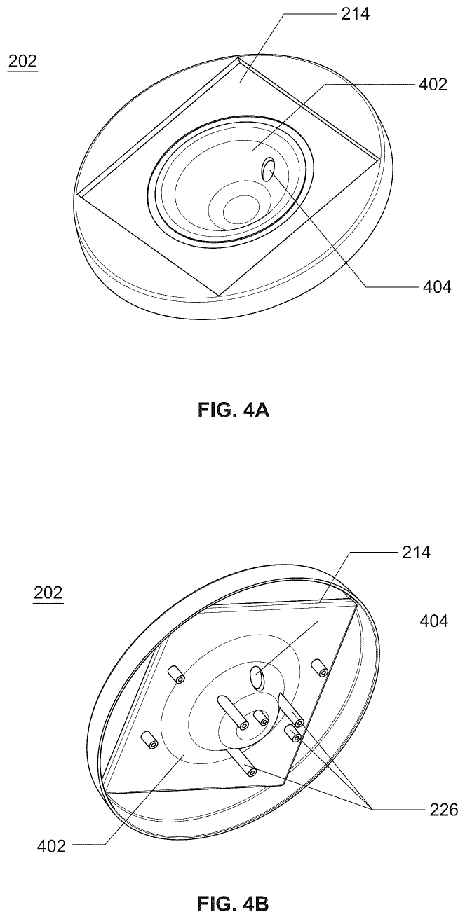

Still referring to FIG. 3, in some cases, a motor 222 or a PCB 224 of the fan may be mechanically attached to the housing 102 of the solar fan assembly 100. In some cases, the motor 222 or the PCB 224 may be mechanically attached to a top portion 221 or a top cover 202 of the housing 102. FIGS. 4A and 4B show perspective views of an embodiment of a top cover 202 of the top portion 221 of a solar fan assembly 100. In some cases, for example, as the embodiment shown in FIGS. 4A and 4B, a top cover 202 of the housing 102 may include a plurality of pillars 226 extending downward, configured to be attached to the PCB 224 or the motor 222, hanging or stabilizing the motor 222 or the PCB 224 inside the cavity 230 of the shaft 106. In some cases, at least one pillar may be provided to attach the PCB 224 to the housing 102, and at least 2, 3, 4, 5, or more pillars may be provided to attach the motor 222 to the housing 102. It may be desirable to have the pillars 226 attached to the motor 222 symmetrically distributed over motor 222 to stabilize the motor 222 during the operation of the fan. The pillars 226 may be attached to the motor 222 or the PCB 224 using adhesive or screws.

Referring to FIGS. 3, 4A, 4B, 12A, 12B, 13A, and 13B, the top cover 202 of the housing 102 may include a base separating the solar panel 206 from a cavity 230 of the shaft 106 or a cavity of the top portion 221 of the housing 102. The pillars 226 may be configured to be attached to the PCB 224, or the motor 222. In some cases, the pillars 226 may extend from a bottom surface of base of the top cover 202. The base of the top cover 202 may include a slot 214 configured to accommodate the solar panel 206. The size of the slot 214 may be provided such that, when the solar panel 206 is fitted into the slot 214, little or no space is left between the solar panel 206 and the top cover 202. The depth of the slot 214 may be provided such that, when the solar panel 206 is fitted into the slot 214, an upper surface of the solar panel 206 is flush with an upper surface of the top cover 202. In some cases, an adhesive or a sealant may be applied between the solar panel 206 and the top cover 202.

In some cases, a significant area of a top surface of the slot 214 may be configured to lie flatly against or directly contact the solar panel 206. In some case, top cover 202 may further include a bulge 402 extending downward from the slot 214, forming a hollow space 234 beneath the solar panel 206. The hollow space 234 may be configured to accommodate electrical connections from the solar panel 206. In some cases, the bulge 402 may include one or more holes 404 connecting the hollow space 234 to the cavity of the shaft 230, allowing electrical connections to pass from the solar panel 206 to the fan. In some cases, the pillars 226 configured to be attached to the motor 222, or the PCB 224 may extend from a bottom surface of the bulge 402.

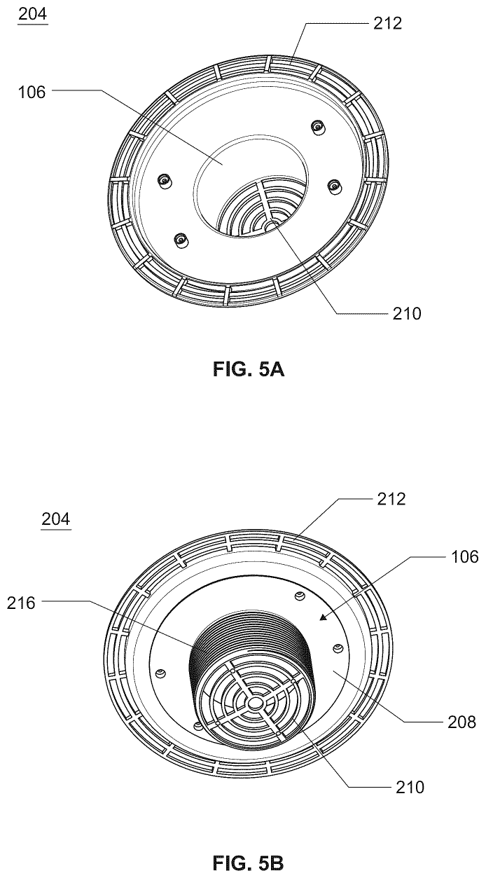

FIGS. 5A and 5B show perspective views of an embodiment of a bottom over and shaft 106 of a solar fan assembly 100. In some cases, for example, as shown in the embodiment of FIGS. 5A and 5B, the bottom cover 204 of the top portion 221 of the housing 102 and the shaft 106 may be integrated into one component. In some cases, the bottom cover 204 of the top portion 221 of the housing 102 and the shaft 106 may first be provided as two separated components, and later assembled or attached to each other. The bottom cover 204 of the top portion 221 of the housing 102 may be configured to be attached to the top cover 202 of the housing 102 through matching mechanisms, for example, through screws and threading. In some cases, through holes may be provided on the bottom cover 204 of the top portion 221 of the housing 102, configured for screws to extend through and be fastened to corresponding threads of the top cover 202.

In some cases, when assembled, the bottom cover 204 and the top cover 202 of the top portion 221 of the housing 102 may form a cavity within the top portion 221 of the housing 102. The cavity may be connected to the cavity of the shaft 230 to allow air to flow between the top portion 221 of the housing 102 and the shaft 106. In some cases, a raised step 208 may be formed on a portion of the bottom surface of the bottom cover 204, such that, when the bottom cover 204 is pressed against a flat surface, another portion of the bottom surface of the bottom cover 204 forms a gap with the flat surface. The raised may be substantially flat or be configured to press against the building structure. For example, in some cases, a center portion of the bottom of the bottom cover 204 may be raised or protrude from a portion on a portion on the perimeter, such that a ring-shaped gap forms beneath the top portion 221 of the housing 102, surrounding the shaft 106. In some cases, an opening of the cavity of the top portion 232 221 of the housing 102 may be arranged facing downwards, directing the air to enter or exit the cavity through the gap. In some cases, the opening 212 may be an outlet of the solar fan assembly 100.

Still referring to FIGS. 5A and 5B, a shaft 106 may extend downward from the bottom cover 204 of the top portion 221 of the housing 102. In some cases, for example, as shown in the embodiment of FIGS. 5A and 5B, the shaft 106 can have a hollow cylindrical body forming a cavity 230 connected to a cavity of the top portion 232 221 of the housing 102. In some cases, a central axis of the shaft 106 may align with a central point of the bottom cover 204. As the shaft 106 may be configured to be inserted through or extend through a hole in a roof or a wall 14, a length of the cylindrical body of the shaft 106 may be slightly longer than some typical thicknesses of walls or roofs of building structures, such that a bottom end of the shaft 106 may protrude from the roof or the wall 14 after being inserted. In some cases, an opening of the cavity of the shaft 230 may be provided at the bottom end of the shaft 106, connecting the cavity 230 to the inside of the building structure. In some cases, the opening may cover an entire bottom surface of the shaft 106. In some cases, a fence or a mesh may be provided over the opening to protect or shield the internal structures from alien objects. In some cases, the opening 210 may be an inlet of the solar fan assembly 100.

Still referring to FIGS. 5A and 5B, in some cases, the shaft 106 can include a mating or fastening mechanism configured to attach the shaft 106 to a fastening collar 104. The fastening mechanism may prevent a relative shift, rotation, or vibration between the shaft 106 and the fastening collar 104, or prevent the fastening collar 104 from sliding away from the shaft 106. In some cases, the mechanism may help create a tension in the shaft 106, which may cause the housing 102 and the fastening collar 104 to clamp or press against a roof or a wall 14, fastening the solar fan assembly 100 to the roof or the wall 14.

In some embodiments, the fastening mechanism may be matching threads, for example, at least a portion of the shaft 106 may be covered in threads 216. In some cases, an external thread or a male thread may cover an external wall of a cylindrical frame of the shaft 106, extending over a significant portion or almost the entire length of the shaft 106. In some cases, the length of the thread in the axial direction of the shaft 106 may extend or cover more than 30% 50%, 70%, 80%, 90%, 95%, or 99% of the length of the shaft 106. In some cases, one or more threads may be provided in isolated vertical strips or columns along an axial direction of the cylindrical frame of the shaft 106, such that an unthreaded portion of the cylindrical frame is provided in between threaded portions. In some cases, the shaft 106 may include more than 1, 2, 3, 4, 5, 6, 7, 8, or 10 strips or columns of threads.

FIG. 7 shows a perspective view of an embodiment of a fastening collar 104 of a solar fan assembly 100. As shown in FIG. 7, a fastening collar 104 can include a cylindrical or an annular frame or body 702, configured to be removably attached or fastened to the housing 102 of the solar fan assembly 100, for example through a thread. The length of the threaded portion 704 in an axial direction of the cylindrical or annular frame 702 may be equal to or shorter than the length of the matching thread 216 of the housing 102. A material of the fastening collar or nut 104 may be identical, similar, or different from that of the housing 102. The fastening collar 104 can be metal, plastic, polymer, carbon fiber, ceramic, or silicone.

In some cases, it may be desirable to adjust the position or height at which the fastening collar 104 fixes or attaches to the housing 102, so that the solar fan assembly 100 can be attached across roofs or walls of various thicknesses. In some cases, the position at which the fastening collar 104 fixes or attaches to the housing 102 may be adjusted such that the distance between a bottom surface of the top portion 221 of the housing 102 configured to press against one side of the roof or wall 14 and a top surface of the fastening collar or nut 104 configured to press against the other side of the roof or wall 14 can be adjusted smoothly or in small increments. In some cases, the fastening collar or nut 104 may be provided with one or more threads 704 that can be screwed or fastened to the housing 102. For example, one or more internal or female threads 704 can be provided on the inner surface of the side wall a cylindrical or an annular frame 702, matching one or more corresponding external or male threads 216 of the housing 102. The length of the threading in the axial direction may extend or cover more than 30% 50%, 70%, 80%, 90%, 95%, or 99% of the length of the frame. In some cases, threading of the fastening ring or collar may be provided in isolated vertical strips or columns along an axial direction, such that unthreaded portion of the frame is provided in between threaded portions. In some cases, there may be more than 2, 3, 4, 5, 6, 7, 8, or 10 strips or columns of threading on the frame of the fastening collar or nut 104.

Still referring to FIG. 7, in some cases, a lip 706 on the end of the fastening nut or collar may be provided to increase an area of mechanical engagement or contact area between the collar and a roof or a wall 14 to enhance the mechanical engagement or to reduce mechanical stress to the roof or wall 14. In some cases, the fastening collar or nut 104 may directly contact the roof or wall 14 of a building structure. In some cases, the fastening collar or nut 104 may engage, press, or clamp the roof or wall 14, or through a buffer, a washer, a seal, an O-ring, or a gasket to enhance the mechanical engagement or to reduce mechanical stress to the wall or the roof. In some cases, the lip 706 may protrude radially from an end of the frame, forming a top surface with an area larger than a cross-sectional area of the frame. In some cases, for example, as shown in the embodiment of FIG. 7, the lip 706 may be provided in the shape of a flat or planar ring or a washer extending radially outward at the top of a cylindrical or annular frame 702 of the fastening collar or nut 104.

In some cases, a lip 706 may not need to protrude from the frame and may simply be provided as an upper surface of the fastening collar 104, by having a significant overall thickness throughout the length of a side wall of the frame of. In some cases, ribs or buttresses 708 connected to the lip 706 may be provided to enhance a mechanical integrity of the fastening collar or nut 104, or to help a tool or a user to hold onto the fastening collar or nut 104 during assembly. A width in the radial direction at the top of the lip 706 may be 1/16-12 inches, ⅛-8 inches, ¼ inch to 4 inches, or ½-2 inches. In some cases, ribs or buttresses 708 may connect the underside of the lip 706 to the outer wall of the frame. In some cases, more than 1, 2, 3, 4, 5, 6, 8, 12, or more individual ribs or buttresses. In some cases, a continuous rib or buttress may be provided around the frame with a substantially triangular, trapezoidal, or rectangular cross-sectional profile.

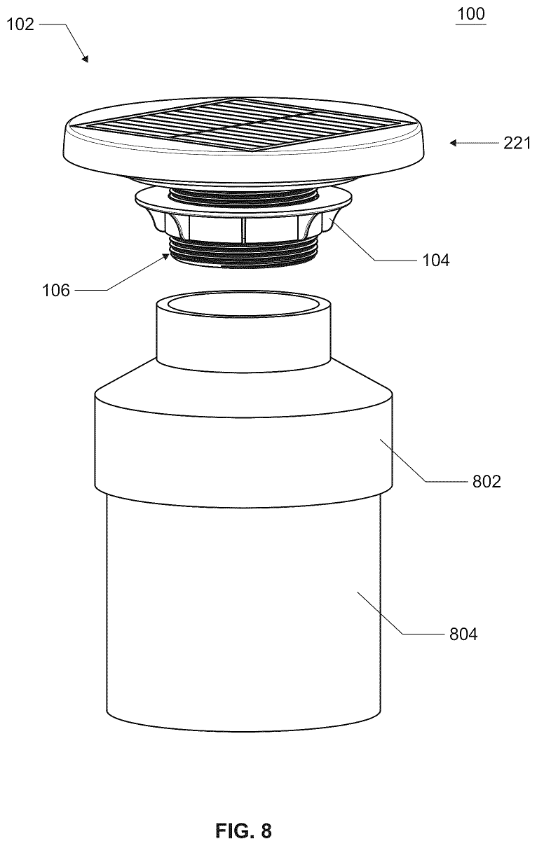

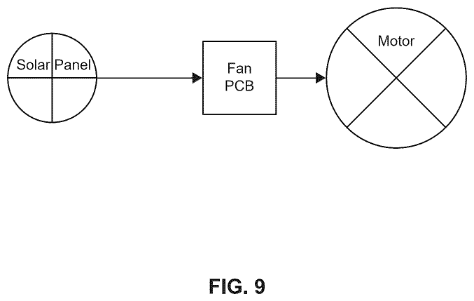

FIG. 8 shows a partially exploded perspective view of an embodiment of a solar fan assembly 100 secured to an exhaust tube with an adapter. In some cases, a building structure may have a pre-existing or a building-in exhaust or vent. For instance, some portable restrooms may have a pre-existing tubular exhaust extending outwardly from the structure. In such cases, instead of attaching the solar fan assembly 100 through a roof or a wall 14, it may be more convenient or cost-effective to attach the solar fan assembly 100 to the pre-existing exhaust or vent.

For example, as shown in the embodiment of FIG. 8, an adapter 802 may be provided to attach the solar fan assembly 100 to tubular exhaust, and to connect a cavity of the solar fan assembly 100 to a cavity of the exhaust. In some cases, the exhaust 804 may have a substantially cylindrical shape, with one end configured to be attached or sealed to the solar fan assembly 100, and another end configured to be attached or sealed to the exhaust 804. In some cases, a first end of the adapter 802 may be connected to a housing 102 of the solar fan assembly 100, for instance, a shaft 106, and a second end of the adapter 802 is configured to connect to external end of the exhaust 804. In some cases, the adapter 802 may be riveted, screwed, or adhered to the housing 102 or the exhaust 804. In some cases, the adapter 802 may be connected to the housing 102 by fitting onto an outer perimeter of the shaft 106, wherein an inner surface of the adapter 802 contacts an outer surface of the housing 102. In some cases, the adapter 802 may connect to the exhaust 804 by fitting to an outer perimeter of the exhaust 804, wherein an inner surface of the adapter 802 contacts an outer surface of the exhaust 804. In some cases, the adapter 802 may include two cylindrical collars connected through an intermediate conical structure, the diameters of the cylindrical collars matching the diameters of the shaft 106 of the solar fan assembly 100 and the exhaust 804, respectively. A seal or a sealant may be provided between the adapter 802 and the solar fan assembly 100 or between the adapter 802 and the exhaust 804.

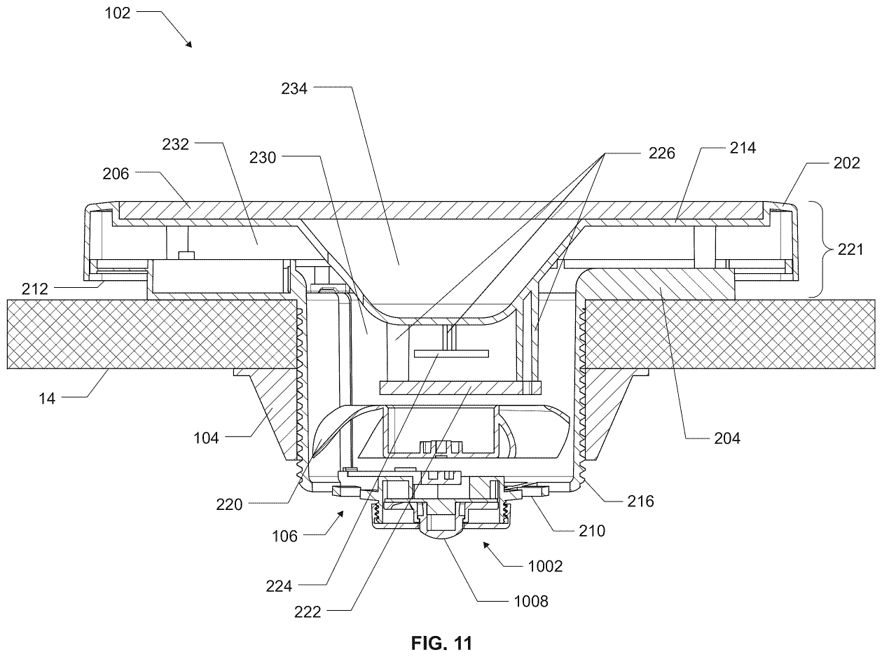

FIGS. 10A and 10B show perspective views of a portion of a solar fan assembly 100 with lights. FIG. 11 shows a section view showing a solar fan assembly 100 with light 1002 secured to a wall or a roof 14 of a building structure with a fastening collar 104. The embodiments discussed below may share certain features similar to those disclosed herein from other embodiments, which will not be described again for brevity.

In some cases, for example, as visible in the embodiments of FIGS. 10B and 11, the solar fan assembly 100 may further include a light 1002 configured to illuminate 18 the building structure, for example, to assist the user when it is dark outside or inside the building structure. The light 1002 may be fixed or removably attached to the rest of the solar fan assembly 100. In some cases, the light 1002 may be attached to the bottom end of the shaft 106 on the inside of the building structure. In some cases, both the light 1002 and an opening or an inlet 210 for airflow 16 may be arranged at the bottom end of the shaft 106, then it may be desirable to arrange the light 1002 only partially over the bottom end of the shaft 106 so as not to block the airflow 16. For example, the light 1002 may be arranged closer to a central region of the bottom end of the shaft 106 and have a size smaller than that of the entire bottom end of the shaft 106. In some cases, the rest of the area at the bottom end of the shaft 106 that is not covered by the light 1002 may be configured as one or more openings for air to flow in or out of the cavity 230. In some cases, the opening of the inlet 210 of the cavity 230 may form a ring around the light 1002.

In some cases, the light 1002 may include one or more colored or white LED elements 1010. For example, the light 1002 may include more than 1, 2, 3, 4, 5, 7, 10, or 20 LED elements 1010. In some cases, the light 1002 may also include a sensor 1004, for example, a motion sensor, that is used to control the light 1002 or one or more LEDs 1010. In some cases, the sensor 1004 may be arranged near the one or more LEDs 1010, for example, in the middle of multiple LEDs 1010. In some cases, the light 1002 may include a cover 1008 removably or fixedly attached to the housing 102 through, for example using threads 1012 at the bottom of the shaft 106. The cover 1008 for the light 1002 may be fully or partially transparent or may shield or seal a portion of the light from environmental factors, for example, may shield or protect one or more LEDs 1010, a sensor 1004, or other electrical connections from air or moisture. And width, diameter, or a size of the cover 1008 of the light 1002 may be smaller than that of the bottom end of the shaft 106, such that the rest of the area may be arranged as an opening or an inlet 210 for airflow 16. A switch 1014 may be arranged at the bottom of the solar fan assembly 100 to control at least one of a battery, a fan, or a light. In some cases, the switch 1014 may be arranged on the inside of the building structure when the solar fan assembly 100 is installed. In some case, the switch 1014 may be arranged on the outside of the building structure when the solar fan assembly 100 is installed. In some cases, the switch 1014 may be arranged at a bottom surface of the housing 102, for example, at the bottom of the shaft 106, or, as shown in FIG. 10B, at a bottom surface of the top portion 221.

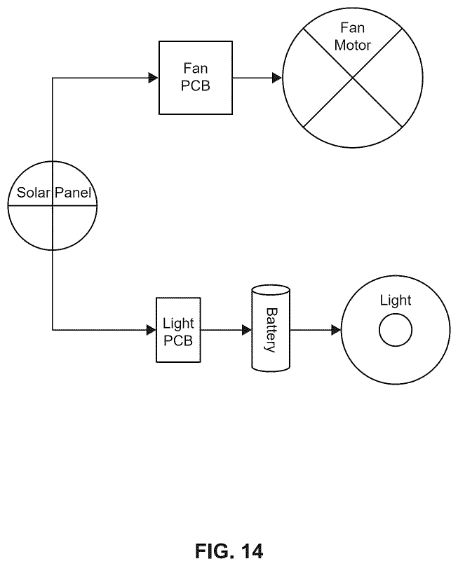

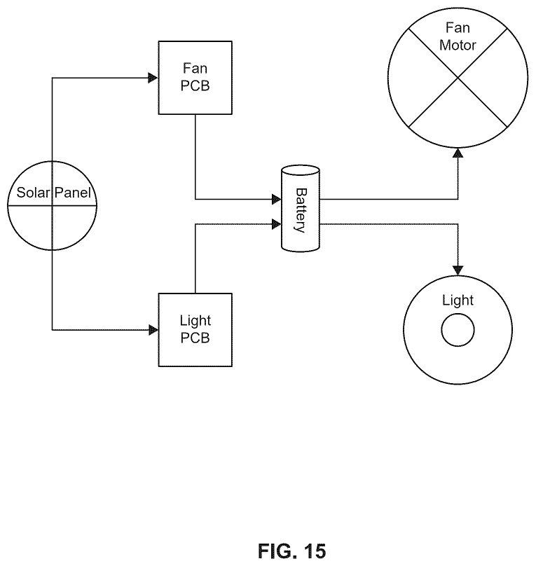

FIG. 14 and FIG. 15 show schematics of embodiments of electrical connection of a solar fan assembly 100 with lights. In some cases, the solar fan assembly 100 may further include a battery or a PCB for powering or controlling the light which is in electrical communication with the solar panel 206. The electricity generated by the solar panel 206, in addition to being passed to the fan, may also simultaneously be passed to the light PCB, the battery, or the light. In some cases, for example, in the embodiment shown in FIG. 14, the electricity generated by the solar panel 206 may first be passed through the light PCB, then to the battery, and finally to the light. In some cases, for example, in the embodiment shown in FIG. 15, the fan may also be powered by a battery, and the electricity generated by the solar panel 206 may first be passed through the fan PCB, then to a battery, and finally to the light.

In some cases, direct electrical connections may also exist between the solar panel 206 and the fan motor or the light. In some cases, direct electrical connections may also exist between the solar panel 206 and the battery, or a PCB that controls the battery. In some cases, a battery may provide power to both the fan and the light. In other words, the fan and the light may share a battery. In some cases, the light PCB and the fan PCB also share one or more circuit boards, electrical connections, or control circuits. In some cases, the electricity generated by the solar panel 206 may be split into one or more portions and provide power simultaneously to any combination of a fan, a light, a battery, a detector, or a sensor. In some cases, in FIG. 14 or 15, separate batteries or different cells of the battery may be provided to power the fan and the light respectively. In some cases, the separate batteries or different cells of the battery may be in electrical communication or controlled by the same PCB. In some cases, the separate batteries or different cells of the battery may be in electrical communication or controlled by different PCBs. For example, in some cases, two batteries may be provided, each of which is charged by the solar panel and each of which separately powers the fan or the light.

In some cases, the solar fan assembly 100 can have an electrical port such that the light can be plugged in to be connected to the rest of the assembly, for example, a USB port, a USB-C port, a micro USB port, or any other port that may be configured to charge or control the light. The port may be arranged on the top portion 221 of the housing 102 or on the shaft 106. In some cases, the port may be arranged on the inside the building structure. In some cases, the port may be arranged on the outside the building structure. In some cases, an electrical cable configured to be plugged into the port may be provided with the light, such that the light may be installed remotely and separately from the rest of the solar fan assembly 100.

In some cases, when the port is arranged on the outside of the building structure, the cable or other portions of the light may pass through a hole in the wall or roof 14 of the building structure such that illumination can be provided to the inside of the building structure. In some cases, the hole the cable passes through may be the same hole that the shaft 106 of the housing 102 passes through. In some cases, the hole the cable passes through may be separate from the hole that the shaft 106 of the housing 102 passes through. In some cases, the cable may go through the shaft 106 of the housing 102. In some cases, the cable may be flexible to allow the light to be installed or arranged away from the housing 102. In some cases, for example, the solar fan assembly 100 is may be installed at a portion of the building structure not directly exposed to the major space of the structure, for example, over an elongated or protruded exhaust of the building structure. In some cases, although the solar fan assembly 100 may be connected to the air inside the building structure, the elongated or protruded exhaust may block or reduce the area which a light arranged directly on the housing 102 can illuminate. Therefore, in some cases, it may be advantageous to arrange the light away from structures that may block the illumination from desired spaces, for example at a portion of the roof or the wall 14 away from the exhaust. For instance, the main part of the housing 102 may be arranged at the top of an exhaust of a portable restroom, while a light of the solar fan assembly 100 may be arranged to illuminate the inside of the restroom, outside of and unblocked by the exhaust.

Still referring to FIG. 14 and FIG. 15, the battery may be charged by the solar panel 206 and store energy when the light level or the amount of power generated by the solar panel 206 is high and may use the stored energy to power the light when the amount of power generated by the solar panel 206 is low. For example, the battery may charge during the day and power the light in the night. In some cases, power generated by the solar panel 206 may not be directly passed to the light or the fan, so that all the power that is passed to the light or the fan first goes through the battery. The battery may be configured to output the stored energy to power the fan or the light, for instance when the light level or the amount of power generated by the solar panel 206 is low, for example, during a cloudy day, during the night, when the light to which the solar panel 206 is exposed to is dim or weak, or when the electrical energy generated by the solar panel 206 is below a certain limit. The battery may also be configured to output energy to assist the fan or the light to operate or output at a certain requested level, for example, when a quality or level of the light to which the solar panel 206 is exposed varies, when power generated by the solar panel 206 varies, or when the power generated by the solar panel 206 is not sufficient for the fan or the light to operate at the requested level. The requested level of the fan or the light may be a constant power, larger than a certain power, or other predetermined, programmed, or user requested level. The battery may stop drawing energy from the solar panel 206 when the power generated by the solar panel 206 is low, such that most or all the energy generated by the solar panel 206 may be used to operate the fan or the light. In some cases, the fan may operate whenever the solar panel 206 is generating electricity. In some cases, the battery may be charged whenever the solar panel 206 is generating electricity.

In some cases, when the solar panel 206 is configured to power or charge at least two of a fan, a light, and a battery, the fan may directly receive from the solar panel 206 at least 95%, 90%, 85, 80%,75%, 70%, 60%, 50%, 30%, or 10% of an instantaneous electrical power generated by the solar panel 206. In some cases, the light may directly received from the solar panel 206 at least 80%, 60%, 40%, 30%, 25%, 20%, 15%, 10%, 5% of an instantaneous electrical power generated by the solar panel 206. In some cases, the battery may receive at least 80%, 60%, 40%, 30%, 25%, 20%, 15%, 10%, 5% of an instantaneous electrical power generated by the solar panel 206. In some cases, at least 90%, 95%, or 100% of the energy powering the fan is directly generated by the solar panel 206 without passing through the battery. In some cases, less than 50%, 20%, 10%, 5%, 2% 1%, or none of the energy powering the light is directly generated by the solar panel 206 without passing through the battery. In some cases, at least 50%, 75%, 80%, 90%, 95%, 99%, or all of the energy powering the light is powered through the battery.

In some cases, one or more internal circuits or a PCB may determine, control, or adjust the power at which the fan operates, the power at which the battery stores energy, ratio of the power split between the battery and the fan depending on one or more electrical signals of the system, for example, from a user operable switch or a control, from a detector or a sensor that measures light, temperature, or motion of either the inside or the outside of the building structure. In some cases, the battery may store greater than 1 mAh, 5 mAh, 10 mAh, 20 mAh, 50 mAh, 100 mAh, 200 mAh, or 500 mAh electrical energy when fully charged. In some cases, the battery may be a lithium battery or other types of rechargeable batteries.

A PCB or a logical circuit may determine, control, or adjust if or how much energy generated by the solar panel 206 is directed to the fan, the battery, or the light. In some cases, the amount of power directed to the battery, the fan, or the light may depend on one or more electrical signals received from one or more of a switch, a control, a detector, or a sensor. In some cases, the amount of power directed to the battery, the fan, or the light may a predetermined constant portion of the total amount of power generated by the solar panel 206 at any instant. In some cases, the amount of power directed to the battery, the fan, or the light may maybe interdependent.

In some embodiments, the light may be provided with a switch configured for a user to control the operation of the light. In some cases, as the solar fan assembly 100 may arrange at a region of the building structure out of reach of a user, for example, on a roof, it might be desirable for the light to be controlled by an automatically. For example, the light may include a detector or a sensor electrical connected to the battery or the light PCB, wherein an operation mode of the light may be determined based on signal obtained by the detector or the sensor. In some cases, the detector or the sensor may be a motion detector, and the light may turn on when a motion is detected by the detector. In some cases, with the both the fan and the light connected to the battery, the light may turn on and the fan may turn off at generally the same time the light is turned on when a motion is detected by the detector. This may be the case when it is dark and the fan and/or light are operating from battery power. When the solar panel is generating power, the fan may be powered while the battery is charged by the solar generated power.

In some cases, one or more batteries may power the light and fan simultaneously. In some cases, one or more batteries may power the light or fan intermittently or alternatively, but not at the same time. In some cases, after a predetermined period of time after the motion is detected, the light may automatically turn off, and the fan may turn on approximately at the same time the light is turned off (e.g., for the fan and the light to be powered by the battery intermittently). In some cases, the fan may keep operating when no motion is detected. In some cases, the motion detector may be an infrared detector, a microwave detector a vibration detector, or an ultrasound detector. In some cases, the detector may send a probe signal by drawing power from the battery. In some cases, the range of the detector may overlap with the range to which the light may illuminate.

In some cases, the light may automatically turn off after a predetermined amount of time, for example, the light automatically turns off in 1 second, 2 seconds, 5 seconds, 10 seconds, 20 seconds, 30 seconds, 45 seconds, 60 seconds, 120 seconds, or 5 minutes after motion is no longer detected by the detector. Automatically turning off the light may help conserve energy, redirect energy to the fan or the battery, or convert the energy stored in the battery. In some cases, the battery may be able to power the light for greater than 12 hours when fully charged, or power the fan for more than 0.5 hours, 1 hour, 2 hours, 5 hours, 8 hours, 12 hours, 18 hours, 24 hours, or 36 hours when fully charged in cases where the battery is connected to the fan and/or light.

The foregoing description of the preferred embodiments of the present disclosure has shown, described, and pointed out the fundamental novel features of the inventions. The various devices, methods, procedures, systems, assemblies, and techniques described above provide a number of ways to carry out the described embodiments and arrangements. Of course, it is to be understood that not necessarily all features, objectives or advantages described are required and/or achieved in accordance with any particular embodiment described herein. Also, although the invention has been disclosed in the context of certain embodiments, arrangements and examples, it will be understood by those skilled in the art that the invention extends beyond the specifically disclosed embodiments to other alternative embodiments, combination, sub-combinations and/or uses and obvious modifications and equivalents thereof. Accordingly, the invention is not intended to be limited by the specific disclosures of the embodiments herein.

What is claimed is:

1. A solar fan assembly to cause airflow through a building structure, the solar fan assembly comprising:
a housing comprising a shaft configured to extend from an inside of a building structure to an outside of the building structure, the shaft forming a cavity configured to direct airflow between the inside of the building structure and the outside of the building structure;
a fastening collar configured to be removably attached to the shaft to secure the housing to the building structure;
a solar panel connected to a top portion of the housing on the outside of the building structure, the solar panel configured to generate electricity from ambient light;
a fan arranged in the shaft, the fan configured to direct airflow through the cavity, the fan in electrical communication with the solar panel to power the fan with the solar panel generating electricity from ambient light;
a light attached to a bottom portion of the housing on the inside of the building structure; and
a battery in electrical communication with the solar panel to charge the battery with the solar panel generating electricity from ambient light, the battery in electrical communication with the light to power the light,
wherein the battery is configured to power the light without the solar panel generating electricity.

2. The solar fan assembly of claim 1, wherein the electricity generated by the solar panel simultaneously powers the fan and charges the battery.

3. The solar fan assembly of claim 1, wherein the light comprises a detector and the light is switched on or off in response to the detector detecting a signal.

4. The solar fan assembly of claim 3, wherein the detector is a motion detector, and the light is switched on in response to the detector detecting a motion.

5. The solar fan assembly of claim 1, wherein the fan is configured to cause an air exchange between the inside of the building structure and outside of the building structure, thereby ventilating the building structure.

6. The solar fan assembly of claim 1, wherein the housing comprises a first thread, and the fastening collar comprises a second thread corresponding to the first thread, and wherein the solar fan assembly is fastened to the building structure by screwing the second thread to the first thread.

7. The solar fan assembly of claim 1, wherein the solar fan assembly further comprises a seal arranged between the housing and an external surface of the building structure, preventing fluid or debris from entering the building structure.

8. The solar fan assembly of claim 1, wherein the solar fan assembly further comprises a PCB configured to control at least one of the fan, the light, or the battery.

9. The solar fan assembly of claim 1, wherein the fan further comprises a plurality of blades and a motor configured to rotate the plurality of blades about an axis of the shaft.

10. A solar fan assembly to cause airflow through a building structure, the solar fan assembly comprising:
a housing comprising:
a shaft configured to extend through an opening in a roof of the building structure, the shaft forms a cavity connecting an inside of the building structure to an outside of the building structure; and
a top portion connected to a top end of the shaft configured to be arranged on the outside of the building structure;
a solar panel connected to the top portion of the housing, the solar panel configured to generate electricity from ambient light;
a fastening collar configured to be removably attached to a bottom end of the shaft and to secure the housing to the roof,
wherein the fastening collar is configured to press against the roof from the inside of the building structure, creating a tension in the shaft, and to cause the top portion of the housing to press against the roof of the building structure from the outside of the building structure; and
a fan configured to direct airflow through the cavity, wherein the fan is in electrical communication with the solar panel to power the fan with the solar panel generating electricity from ambient light.

11. The solar fan assembly of claim 10, wherein the bottom end of the shaft is configured to protrude from under the roof.

12. The solar fan assembly of claim 10, wherein the top portion of the housing further comprises a top cover with an upper surface and a lower surface,
wherein the upper surface is connected to the solar panel and the lower surface is connected to the top end of the shaft, and
wherein the lower surface comprises vents connecting the cavity to the outside of the building structure.

13. The solar fan assembly of claim 10, wherein the shaft comprises a first mechanism, and the fastening collar comprises a second mechanism configured to be fastened to the first mechanism, preventing the fastening collar from sliding relative to the shaft in an axial direction of the shaft.

14. The solar fan assembly of claim 10, wherein the shaft comprises a cylindrical body at least partially by an external thread, wherein the fastening collar comprises an annular frame at least partially covered by an internal thread matching the external thread of the shaft.

15. A solar fan assembly to cause airflow through a building structure, the solar fan assembly comprising:
a housing comprising a shaft configured to extend from an inside of a building structure to an outside of the building structure, the shaft forming a cavity configured to cause airflow between the inside of the building structure and the outside of the building structure;
a fastening collar configured to be removably attached to the shaft to secure the housing to the building structure;
a solar panel connected to a top portion of the housing on the outside of the building structure, the solar panel configured to generate electricity from ambient light; and
a fan arranged in the shaft, the fan configured to direct airflow through the cavity, the fan in electrical communication with the solar panel to power the fan with the solar panel generating electricity from ambient light.

16. The solar fan assembly of claim 15, wherein the fan is configured to direct airflow from the inside of the building structure to the outside of the building structure.

17. The solar fan assembly of claim 15, wherein an output power of the fan is proportional to electrical power generated by the solar panel.

18. The solar fan assembly of claim 15, wherein the housing further comprises an inlet at a bottom portion of the shaft connecting the cavity to the inside of the building structure.

19. The solar fan assembly of claim 15, wherein the top portion of the housing further comprises an outlet on the outside of the building structure, connecting the cavity to the outside of the building structure.

20. The solar fan assembly of claim 15, wherein a gap is formed between the top portion of the housing and the building structure, wherein an opening of the cavity is configured to direct air to flow through the gap.

21. The solar fan assembly of claim 15, wherein the shaft comprises a first thread, and the fastening collar comprises a second thread matching the first thread, and wherein the solar fan assembly is fastened to the building structure by screwing the second thread to the first thread.

22. The solar fan assembly of claim 15, wherein the solar fan assembly further comprises an adapter configured to attach the housing to an exhaust of the building structure, such that the cavity of the shaft is connected to a cavity of the exhaust, and wherein a first end of the adapter is configured to connect to a bottom portion of the housing, and a second end of the adapter is configured to connect to the exhaust.
